(19) United States
(12) Patent Application Publication
(10) Pub. No.: US 2004/0233225 A1
(43) Pub. Date: Nov. 25, 2004

(54) Digital video display device

(76) Inventor: Philippe Guillemot, Montreal (CA)

Correspondence Address: Smart & Biggar, Suite 3400, 1000 de la Gauchetiere Street West, Montreal, QC, H3B 4W5, CA

(21) Appl. No.: 10/433,278

(22) PCT Filed: Dec. 11, 2001
(86) PCT No.: PCT/FR01/03908

(30) Foreign Application Priority Data
Dec. 12, 2000 (FR) 00/16620

(51) Int. Cl. G09G 5/02

(52) U.S. Cl. 345/690; 345/694

(57) ABSTRACT

Device for a digital video screen comprising one or more printed circuit substrates on which are mounted one or more integrated circuits covered by a one-piece display surface. The display surface is covered by one or more luminous substances that are excited by the integrated circuits placed underneath. A video screen is formed where each subpixel is composed of a certain number of basic luminous units activated or deactivated by electrical switches on logic controls. Binary words are applied on the logic controls, and correspond to values of desired colors for each sub-pixel in such a way that the image refresh rate is independent of the loading rate, the rate of change, the resolution of the displayed image and the dimension of the video screen.

### FIELD OF INVENTION

The present invention relates to a video screen characterized by a display device that is entirely digital having non-limiting applications in computer video screens and televisions having a small thickness and having a large, one-piece display that is planar, cylindrical or spherical.

### BACKGROUND OF THE INVENTION

Nearly all elements of today constituting the “video chain” are digital, since the capture of an image by CCD cell digital cameras, image processing, transmission and reception of digital circuit televisions.

Nevertheless, in the present state of technology, video screens belonging to the “last link”, specifically video displays, are not really digital. In effect, video display devices that are type CRT, liquid display, plasma, plasma controlled crystal liquids, electroluminescent diodes, micro mirror modules, field effect etc. use electronic circuits that transform digital signals into either analog signals, or else into frequency modulated signals allowing global variation of the intensity emitted by red, green and blue subpixels, grouped into triplets or pixels to form a video screen. According to the three color additive law, the sum of the intensity of each sub-pixel emitting the primary colors red (R), green (G) and blue (B) light, forming a triplet RGB referred to as pixel, results in a color that is characteristic of the sum of luminous intensity of the three sub-pixels. Each red, green and blue sub-pixel has 256 levels of intensity, resulting in more than 16 billion different colors per RGB pixel.

In the current state of technology, giant video screens are implemented by assembling an array of smaller screens that are placed side-by-side. Connected to a high-speed electronic video, an image is decomposed into as many elements as there are smaller screens in the mosaic. The screens forming the mosaic can be of the CRT type, diode panels, overhead projectors, video or liquid crystals, micro mirrors etc. These giant screens are dozens of inches thick and are large energy consumers. In fact, the inherent limitations of these different types of screens imposes the use of a screen array as soon as it is desired to have display dimensions greater than that of a single screen. In general, the limitations of each of these technologies are such that for LCD screens, it is not possible to have a video screen as a single unit of more than 20 diagonal inches it, and for CRT and plasma screens, it is not possible to go beyond 42 diagonal inches.

Present techniques also have limitations with respect to image refresh rate. There exists a narrow relationship between the refresh rate, that is, the number of times per second that the image is reconstituted by the display, and image resolution, that is, the number of points per line by the number of lines per image, and the loading rate or image change rate, that is, the number of images displayed per second (for a film is 25 images/s in Europe and 30 images/s in North America), and the image dimensions. In effect, whatever the image change rate, whether 25 or 30 images/s, the greater the resolution and/or the dimension of the image, the less the image refresh rate is. This is due to the way the different display technologies work. The currently used display technologies can be grouped into two broad categories: scanning techniques for CRT, micro mirror and field effect type screens, and matrix techniques for diode type, liquid crystals and plasma screens. Commercial television screens now attaining a refresh rate of 100 Hz for a 42-inch diagonal dimension are near a maximum performance level. Good quality computer screens with display dimensions from 17 to 22 inches diagonal attain 240 Hz for a resolution of 640 points for 480 lines, but this refresh rate decreases rapidly down to 120 Hz for 1024×768 resolution, to 75 Hz for 1600×1200 resolution.

The current techniques can only provide screens whose surface is planar or slightly cylindrical, in the case of multi-screen arrays, where the thickness of the screen grows with the diagonal dimension of the display surface. None of those techniques allow for a giant one-piece screen where the display surface is planar, cylindrical or spherical while remaining thin.

### OBJECT OF THE INVENTION

The object of the present invention is thus to provide a new integrated circuit based display for making video screens having five principal characteristics. First, the video screen is entirely digital having a thickness comparable to that of a LCD. Second, the refresh rate is very high and independent of the resolution, the image change rate and the display dimensions of the images. Third, each displayed image appears all at once without pixel scanning or requiring matrix addresses. Fourth, the video screen always has a small thickness and a one-piece display surface, even for giant screens with dimensions greater than 42 inches diagonal. Fifth, the screens can provide display surface having any possible shapes: planar, cylindrical and even spherical.

### BRIEF DESCRITGION OF THE DRAWINGS

FIG. 1 is a diagram of a digitally controlled basic luminous unit.

FIG. 2 is a timing diagram of the digitally controlled basic luminous unit.

FIG. 3 is a set of digitally controlled basic luminous units connected together according to a preferred embodiment of the present invention.

FIG. 4 is an address table of the set of digitally controlled basic luminous units connected together according to a preferred embodiment of the present invention.

FIGS. 5 and 6 are equivalent electrical circuit diagrams and operation diagrams of the digitally controlled basic luminous unit according to a preferred embodiment of the present invention.

FIG. 7 is a diagram of a basic luminous unit with a digital control device.

FIG. 8 is an equivalent diagram of the basic luminous unit with the digital control device.

FIG. 9 is a cross sectional view of a basic luminous unit with a digital control device, according to a preferred embodiment of the invention.

FIG. 10 is a cross sectional view of a set of digitally controlled basic luminous units forming a subpixel, according to a preferred embodiment of the invention.

FIG. 11 shows the relationship established between a subpixel and a set of digitally controlled basic luminous units according to a preferred embodiment of the present invention.

FIG. 12 is an electrical circuit diagram equivalent of a set of digitally controlled basic luminous units and their inputs, forming a subpixel, according to a preferred embodiment of the present invention.

FIG. 13 is an equivalent diagram of the electronic circuit of the subpixel shown at FIG. 12.

FIG. 14 is an electrical connection diagram of the subpixel shown at FIG. 13, connected to a double memory device, according to a preferred embodiment of the present invention.

FIG. 15 is an equivalent diagram of the electronic circuit shown in FIG. 13.

FIG. 16 is an electrical connection diagram of a set of three subpixels shown in FIG. 16, connected to a loading device, according to a first preferred embodiment.

FIG. 17 is an equivalent diagram of the electronic circuit shown in FIG. 16.

FIG. 18 is an electrical connection diagram of a set of n by m (n,m) subpixels, shown at FIG. 17, forming an (n,m) block of subpixels according to a first preferred embodiment.

FIG. 19 is an equivalent diagram of the electronic circuit of the block of (n,m) subpixels shown in FIG. 18.

FIG. 20 is a timing diagram of the electronic circuit forming the block of (n,m) subpixels of FIG. 19.

FIG. 21 is an electrical connection diagram of a set of (n,m) blocks of subpixels, shown in FIG. 19, forming a screen of (n,m) blocks of subpixels, according to a first preferred embodiment.

FIG. 22 is an electrical connection diagram of a video screen formed from (n,m) blocks of subpixels, shown in FIG. 21, according to a first preferred embodiment.

FIG. 23 is an electrical connection diagram of a block of (n,m) subpixels shown in FIG. 17, and forming a block of (n,m) subpixels according to a second preferred embodiment.

FIG. 24 is an equivalent diagram of the electronic circuit of a block of (n,m) subpixels shown in FIG. 23, according to the second preferred embodiment.

FIG. 25 is an electrical connection diagram of a video screen formed from (n,m) blocks of subpixels shown in FIG. 24, according to a second preferred embodiment.

FIG. 26 is an electrical connection diagram of a set of three subpixels shown in FIG. 15, with a loading device allowing the formation of a triplet, referred to as pixel, according to a third preferred embodiment.

FIG. 27 is an equivalent diagram of the electronic circuit of the triplet, referred to as pixel, shown in FIG. 26, according to the third preferred embodiment.

FIG. 28 is an electrical connection diagram of a block of (n,m) pixels shown in FIG. 27, according to the third preferred embodiment.

FIG. 29 is an equivalent diagram of the electronic circuit of a block (n,m) of pixels shown in FIG. 28, according to the third preferred embodiment.

FIG. 30 is a connection diagram of a video screen formed from (n,m) blocks of pixels shown in FIG. 29, according to the third preferred embodiment.

FIG. 31 is a video screen with its principal elements.

### DETAILED DESCRITGION OF THE INVENTION

The preferred embodiment of the present invention is provided herein solely as an example.

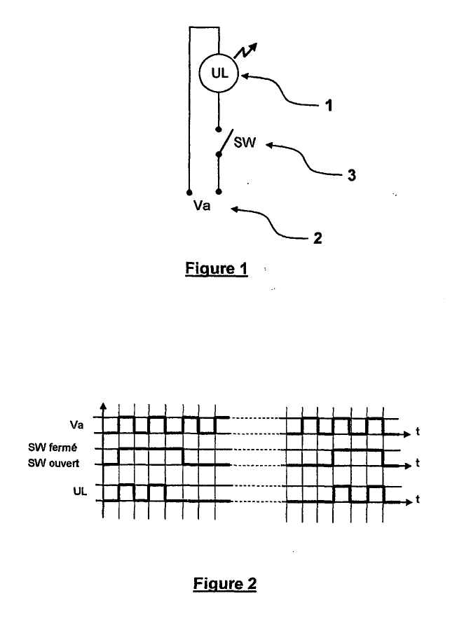

The device illustrated in FIG. 1 comprises a means 1, referred to as a basic illumination cell LU, which is directly connected to one of the terminals of a means 2, referred to as an input source Va, and is connected to the other terminal of the means 2 through an intermediary of a means 3, referred to as switch SW.

FIG. 2 is a diagram showing the operation of the device in FIG. 1. The input source 2 Va is constantly present as either a continuous or periodic voltage, and is or is not applied to terminals of the basic cell LU depending on whether the switch SW is open or closed. Every time the switch SW is closed for a certain amount of time, the means 1, referred to as basic luminous unit LU, emits one or more photon fluxes, that is, a number of photons discharged per unit of time in a photonic unit system. Such flux is characterized by its nature and type of input Va applied. By selecting an input Va suitable to the nature of the basic luminous unit LU, the behavior of the basic luminous unit LU can be controlled in that for a given basic amount of time Va is applied (called herein “Te”), the same basic photon flux (called herein “φe”) will always be emitted by LU. Since the basic luminous unit 1 emits the flux according to a corresponding solid corresponding angle, the basic flux φe is equivalent to a basic luminous intensity output by the luminous unit 1.

FIG. 3 is a connection diagram of a set of means 1, referred to as basic luminous units LU, arranged in a 16 by 16 array and connected to an input source 2 Va by an intermediary means 3, which are switches SW numbered from 1-8, according to a non-limiting example of implementation of the present invention. The darkened means 1, referred to as LU, represent the LUs that are not activated by the input source Va because the switches 3 that they are connected to are open. The lighter LUs represent those that are activated by the input source 2 Va because the switches 3 that they are connected to are closed. The switches 3 numbered from 1-8 thus allow application or non-application of the input source Va to groups of LUs according to the preferred non-limiting embodiment. In the embodiment, the switches 3 allow grouping a number of LUs equal to the power of (n-1), where n is the number of switches to which the LU connect to the input source Va.

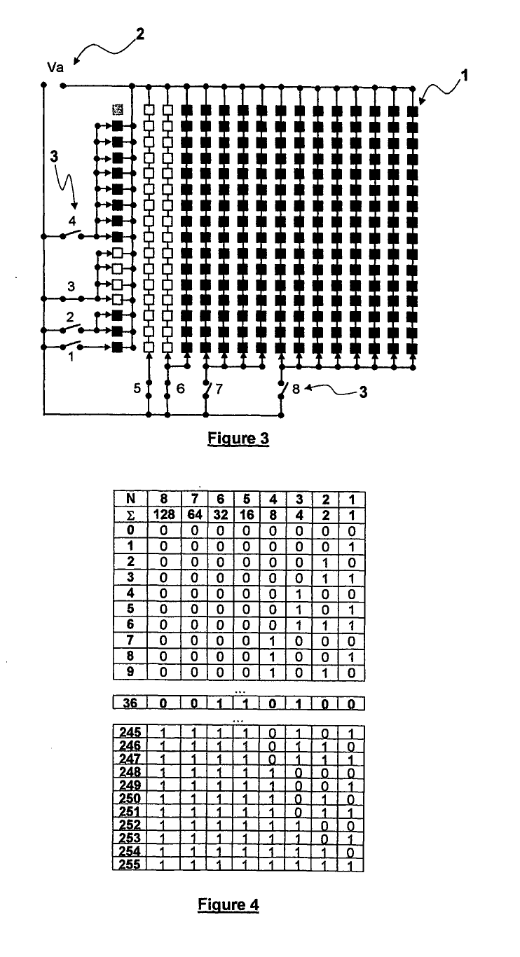

FIG. 4 is an address table showing that 1-255 means 1, referred to as basic luminous unit LU, can be activated using only 8 address bits applied to the switches 3, numbered 1-8. The switches allow or do not allow application of the input source Va to the groups of LU according to the non-limiting example of implementation. In particular, when all switches 3 are open, the address controls of SW are all zero (0), and all the LU are deactivated and do not emit any photon flux, whereas when all switches 3 are closed, the address controls are all one (1) and all the LU are activated and emit a basic flux φe at the same time, resulting in a total flux φsp=255×φe. Each means 1, referred to as LU, emits the same basic photon flux φe when activated. In accordance with this non-limiting example of implementation, a resulting flux φsp capable of having 1-255 times the flux 10, as the basic flux φe can be obtained. Thus, in addition to a resulting flux φsp=0 when nothing is activated, there are 256 possible values for the resulting flux φsp.

Many kinds of LU and suitable types of input Va will achieve this result. In a non-limiting example, the LU are simple filament or flash lamps, electroluminescent LED diodes and thin film electroluminescent (TFEL) or plasma cells. Non-limiting examples of input Va are a frequency or alternating voltage such that when the switches SW are transistors that connect or disconnect the lamps, diodes or TFEL or plasma cells from the input Va, the lamps, diodes or TFEL or plasma cells will respectively emit or do not emit the basic flux φe. The LU can also be liquid crystal cells, light emitting polymer (LEP) or micro mirrors that are or are not activated depending on whether the switches SW connect them to the input Va such that there is a continuous voltage.

These solutions can all be practically implemented, but present constraints and limitations that do not give results as satisfying as those of the now-described device and which is a preferred, non-limiting embodiment of the present invention for attaining the objectives stated earlier.

FIG. 5 is an electronic connection diagram of the preferred embodiment, and next to it is a corresponding specific operations diagram. A means 1, referred to as basic luminous unit LU, is a cell containing a gas composition having particular luminous properties when suitably excited and ionized by a suitable input. A means 4, referred to as capacitance C, is connected to one of the terminals of means 1 and to one of the terminals of an input source 2 Va via switch 3. The other terminal of the input source 2 Va is directly connected to the other terminal of the basic luminous unit 1. In a non-limiting example, the input source 2 Va generates an alternating voltage represented on the diagram by a sinusoidal curve VOLTAGE_Va. The dotted VOLTAGE_PT_A curve shows in a simplified manner, variations of the voltage measured at a point A in the connection diagram. The connection diagram illustrates two modes of operation, depending on whether the switch 3 is open or closed, which is represented by the curve STATE_OF_SW. In the first mode, if switch 3 is open, no input voltage Va is applied to the device and nothing happens since the basic unit 1 is not connected to the input source 2 Va, which is thus deactivated or unlit. In the second mode, switch 3 is closed and the input voltage Va is thus applied to the whole circuit. The VOLTAGE_PT_A curve shows that the voltage measured at point A remains at a constant value until the absolute value of the input voltage |Va| reaches a value |Vi|, referred to as an ionization voltage. The ionization voltage |Vi| is precise and specific to a gas, that when ionized, becomes luminous. When the absolute value of the input voltage |Va| is less than the ionization voltage |Vi|, internal resistance of the gas contained in the basic cell LU is so high that the internal resistance can be considered infinite. No current passes through the gas that is not ionized and the gas does not emit luminescence. From the moment that the input voltage |Va| reaches the ionization voltage |Vi|, the gas contained in the basic elementary unit LU cell ionizes and becomes luminous whereas the internal resistance diminishes sharply. The current passing through the luminous ionized gas is sufficient to charge the capacitance 4 such that the voltage at point A raises toward the input voltage Va until reaching a value of ±|Vi+ΔV| (± depends on current direction) is reached. By tracking the input voltage Va, the absolute value of the difference between the potential applied to the terminals of the basic cell 1 goes below the absolute value of the ionization voltage |Vi| and the ionization of the gas and its accompanying luminescence stops. The current no longer passes through and the voltage measured at point A is maintained at the value |Vi+ΔVi|. The STATE_OF_LU curve in the diagram shows that for a period of the input voltage Va, when peak-to-peak amplitude is slightly more than 2 times the absolute value of the ionization voltage |Vi|, four luminous ionizations of the gas for basic cell 1 are obtained when switch 3 is closed. If the input voltage Va has a peak-to-peak voltage slightly more than one times the absolute value of the ionization voltage |Vi|, 2 luminous ionizations per period are obtained, whereas if the input voltage Va has a peak-to-peak amplitude slightly more than 4 times the absolute value of the ionization voltage |Vi| 8 luminous ionizations per period are obtained, etc. In the preferred embodiment, the ionization time Ti of the gas and therefore of the luminescence of the basic cell 1, is essentially a function of the resistance of the input source, the nature and pressure of the gas and the value of the capacitance C. However, no matter the value of these parameters, the ionization time Ti of the gas is globally always the same in this type of function, which makes the basic cell LU emit by luminescence basic photon flux φe having globally identical values with each ionization of gas during the basic time Te=Ti.

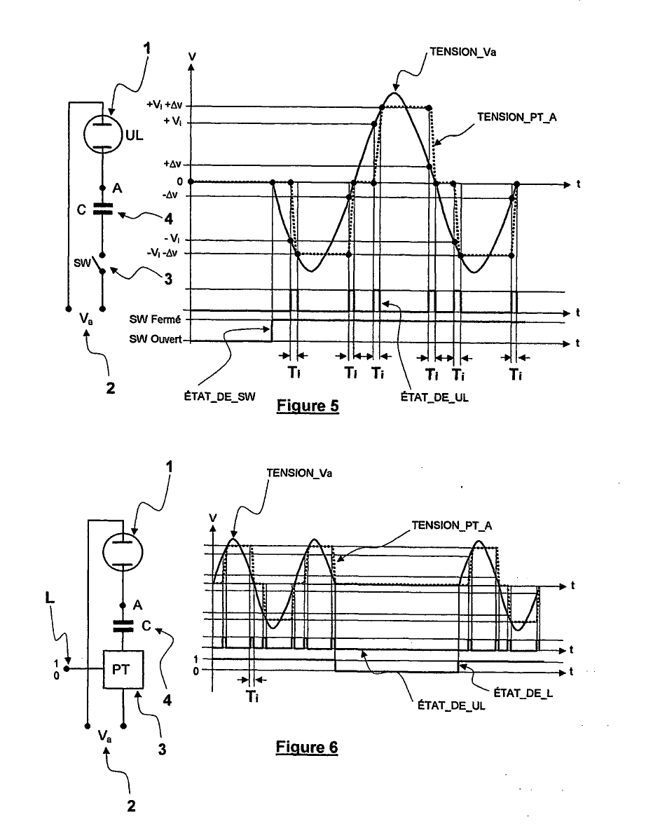

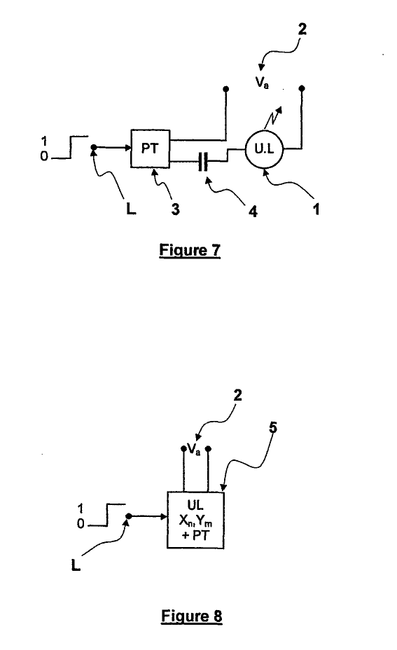

FIG. 6 shows the same arrangement as FIG. 5 except the switch SW has been replaced by a digitally controlled electronic transfer gate TG, which in a non-limiting example is comprised of transistors, such that the circuit may or may not be in communication with the input source 2 Va, depending on whether a logical input L is one (1) or zero (0) which is represented by curve STATE_OF_L in the diagram. Hence, the diagram shows the operation of the device over several periods and shows the input voltage Va, the voltage measured at point A and the luminous ionization impulse curve STATE_OF_LU. Several conclusions can be drawn from the diagram. First, if the frequency of the input voltage is raised, the function of the device does not change, only the interval between each ionization impulse is reduced which means an increase in their frequency, hence in the luminous impulses of the basic flux φe. Likewise, if the peak-to-peak value of the input voltage is increased such that the value is slightly greater than a multiple of the ionization voltage Vi, the number of ionizations per period is multiplied which also decreases the interval between them, hence increasing the rate of luminous impulses φe. Of course, the two cases can be combined by increasing both the rate and the peak-to-peak amplitude of the input voltage to increase the rate of luminous impulses φe. In all cases, since the slope of the input voltage increases, the ionization time Ti and hence the duration of the luminous impulses of basic flux φe decrease, though globally they will always have the same value. In the preferred non-limiting embodiment, globally identical luminous impulse rates φe of several kHz or even MHz can be obtained, each of the luminous impulses φe being the result of an ionization of duration Ti during which a basic flux φe is emitted over basic time Te=Ti. Thus, the transfer gate serves as a simple digital binary control allowing luminous impulses emitting basic photon flux φe. Since the rate of luminous impulses φe can be very high, the rate of the digital control transfer gate can also be high, easily 25-30 Hz, if not greater.

FIG. 7 is a diagram of a basic luminous unit 1 connected to one of the terminals of the input source 2 Va and connected to a capacitance 4. The capacitance 4 is connected to a transfer gate 3, which is connected to the other terminal of input source 2 Va. The transfer gate 3 is set by a digital control input L accepting two logic states, zero (0) and one (1).

FIG. 8 is an equivalent diagram of the electronic circuit of FIG. 7. A circuit 5 comprises the set of luminous unit 1, the capacitance 4 and the transfer gate 3. The circuit can be connected to an input source 2 Va and an input L receives a binary logic control.

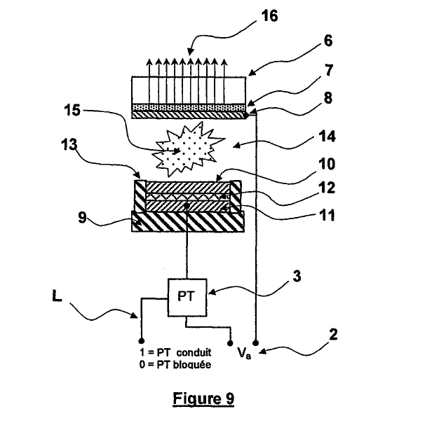

FIG. 9 is a physical cross sectional view of a preferred embodiment for a basic luminous unit with a digital control device. An interior face of a transparent support 6 receives a layer of luminescent substance 7 and a transparent electrode 8. At a suitable distance is an insulating support 9. On one of the faces of insulating support 9 is placed electrodes 10 and 11, which are separated by a dielectric 12. The set of means 10-12 forms a capacitor 4, which is surrounded by an insulator 13. The electrode 8 is implemented using a uniform conducting substance transparent to photon flux, or in form of a fine conducting grid that is directly connected to one of the terminals of the input source 2 Va. The electrode 11 is connected to a transfer gate 3, which is connected to the other terminal of the input source 2 Va. The transfer gate 3 blocks or conducts depending on the application of a logical signal zero (0) or one (1) to an input L. Inverse logic can also be applied. Between the two sets of means 6-8 and 10-12 is a gas 14 having a composition and pressure similar to those used, in a non-limiting example, in plasma screens that when suitably excited and ionized emit by luminescence a flux of photons 15 having a wavelength characteristic of their composition and pressure. When the transfer gate 3 is blocked, for example from the application of a 0 at the input L, nothing happens since no voltage outputs from the input source 2 Va to apply to the device. When the transfer gate 3 conducts, for example from the application of a 1 at the input L, there is a series of ionization impulses of gas 14 that generate a corresponding series of luminous impulses 15 and therefore a basic photon flux φe having a particular wavelength. The basic photon flux φe having a particular wavelength traverses the electrode 8 and is transformed by the luminescent substance 7. The luminescent substance 7 emits by luminescence a basic photon flux φe, represented by arrows 16, having a wavelength characteristic of its composition and which passes through the transparent support 6 which can be glass or polycarbonate. In a non-limiting example, the compositions of the luminescent substances 7 can be similar to those used in plasma screens, and depending on its composition, emits photon flux corresponding to primary colors of red, green and blue light, or a mixture of these colors to obtain white or any other specific color. In contrast to existing plasma devices, the activation voltage is much weaker, in the order of volts or dozens of volts, since it relates to the ionization voltage |Vi|. Furthermore, there is no need for supplementary electrodes for the voltage maintaining discharges, nor a device for discharge currents control since the arrangement uses high frequency basic luminous ionization impulses φe where discharge currents are self-limited by the capacitance 4. The capacitance 4 is a few nano or dozens of nano farads depending on the conductance of the ionized gas and the ionization time value Ti that is desirably obtained as basic time Te for the basic flux φe. The device therefore consumes very little current, on the order of micro amps, because it concerns ionization of plasma which will always work in a subnormal and normal luminous mode of discharge without ever entering a luminous arc mode that is a great consumer of current and that causes energy dissipation by heating the plasma.

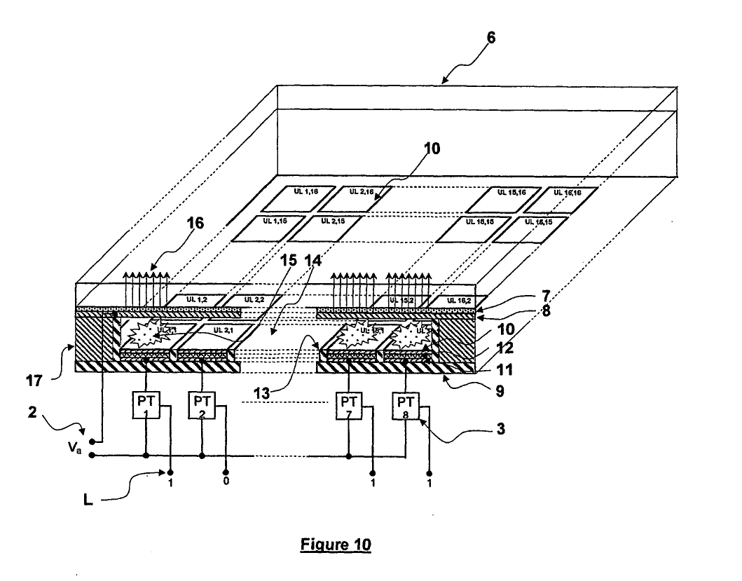

FIG. 10 is a cross sectional view of a preferred embodiment of a set of identical, digitally controlled basic luminous units LU similar to the one in FIG. 9, forming a subpixel. The basic units LU are arranged in a 16 by 16 array connected according to the preferred arrangement shown in FIG. 3, to transfer gates numbered TG1-TG8. A means 17 delimits the set. A support 6 covers the set and itself is covered by a common layer of substance 7 and by a common electrode 8 which is shared by the set of luminous units and directly connected to the input source 2 Va. FIG. 10 shows, for example, that when a logic control (1) is applied to the input L of one or more transfer gates 3, luminous gas ionization impulses 15 are enabled, whereas they are disabled when a logical zero (0) control is applied to the input L of one or more transfer gates 3. A binary word of n=8 bits allows 2ⁿ, or 256 values, of total photon flux emitted by identical impulses φsp=2ⁿ×φe by the luminescent substance 7 at a rate that is a function of the input source 2 Va, in accordance with what was previously explained for FIG. 6. Each basic luminous unit LU that composes the device can and should function independently. The capacitances 4 of each LU are separated by an insulator 13 in order to avoid charge transfer phenomena between neighboring active luminous units, which would modify the function and duration Te=Ti of each ionized basic luminous impulse φe. The cross sectional view shows a non-limiting example of a set forming a red, green or blue subpixel, depending on the emission corresponding to the composition of the luminescent substance 7, either a red, green or blue wavelength in response to the photon flux 15 emitted by luminescence of the gas 14 for each of the LUs that are activated by their transfer gate 3.

FIG. 11 shows the relationship between each subpixel 18 of the RGB matrix of a video screen and a set of digitally controlled basic luminous units LU, in accordance with a preferred embodiment of the present invention. Each sub pixel 18 is decomposed, according to the preferred embodiment, into an array of 16 by 16 means 19, each means comprising a basic luminous unit LU 1 and a capacitor. The means 19 are directly connected, according to the preferred embodiment, to an input source 2 Va and to a transfer gate 3, numbered TG1-TG8, with digital controls L1-L8 at the input. The dimensions of the basic luminous units 19 are such that the dimensions of the set correspond to a desired dimension for a corresponding subpixel. Using a binary word of n=8 bits applied to the digital controls of the transfer gates 3, an activation of 1-255 basic luminous units in accordance with FIG. 4 can be obtained. A total flux of φsp=2ⁿ×φe emitted by impulses for each subpixel having 1-256 values is obtained since the deactivation of all LU of a subpixel, corresponding to total blackness, counts as one value. The number of basic luminous units can also be increased or decreased to obtain a total flux φsp=2ⁿ×φe having more or less values. For example, a binary word having a corresponding number of bits n can be used to implement video screens requiring more or less colors, or bi-color screens referred to as monochromes, or half tones used for alphanumeric information displays and/or graphics.

FIG. 12 is an equivalent electronic diagram of a set of digitally controlled basic luminous units and their inputs, forming a subpixel in accordance with the preferred embodiment described in FIG. 3. Each of the luminous units 1 is directly connected to a common terminal of input source 2 Va and to a capacitance 4. The capacitance 4 is connected to a transfer gate 3, in accordance with the preferred embodiment of FIGS. 3 and 11, and is connected to the other terminal of input source 2 Va depending on whether the digital control inputs L1-L8 of the transfer gates 3 receives a corresponding logic value.

FIG. 13 is an equivalent diagram of the electronic circuit of a subpixel. A circuit 20 is a set of elements described in FIG. 12, with inputs connected to an input source 2 Va and to digital control inputs L1-L8 of transfer gates 3. The function of the electronic circuit is simple since it suffices to apply a suitable input source Va, as described in FIGS. 5 and 6, to obtain a subpixel whose set of basic impulses of photon flux emitted by luminescence would have a value of φsp=2ⁿ×φe, which is determined by the value of an n=8 bit binary word applied to inputs L1-L8. It has already been noted that the impulse rate of flux φsp is independent of the rate at which the value of the n=8 bit binary word that is applied to inputs L1-L8 changes.

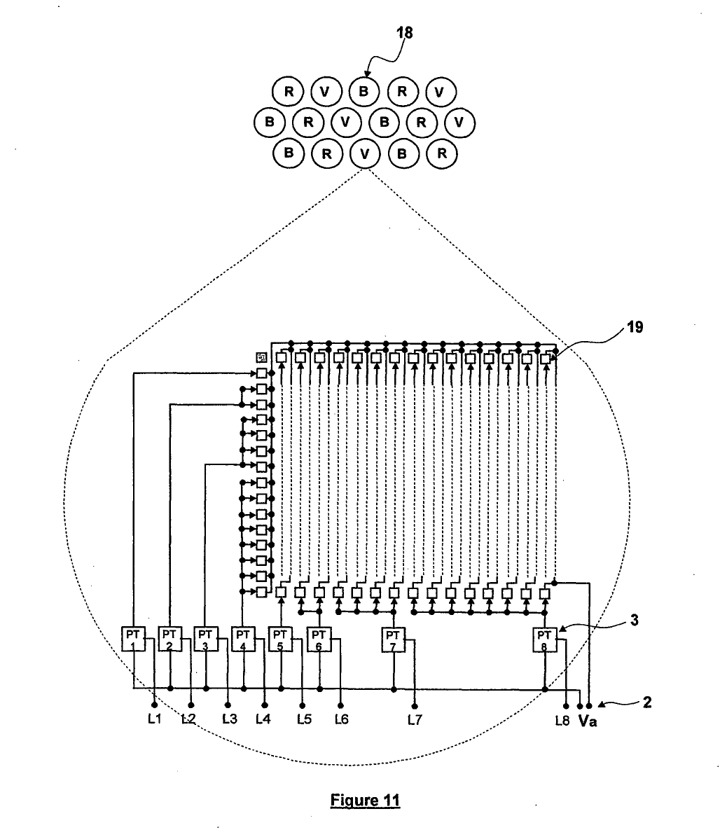

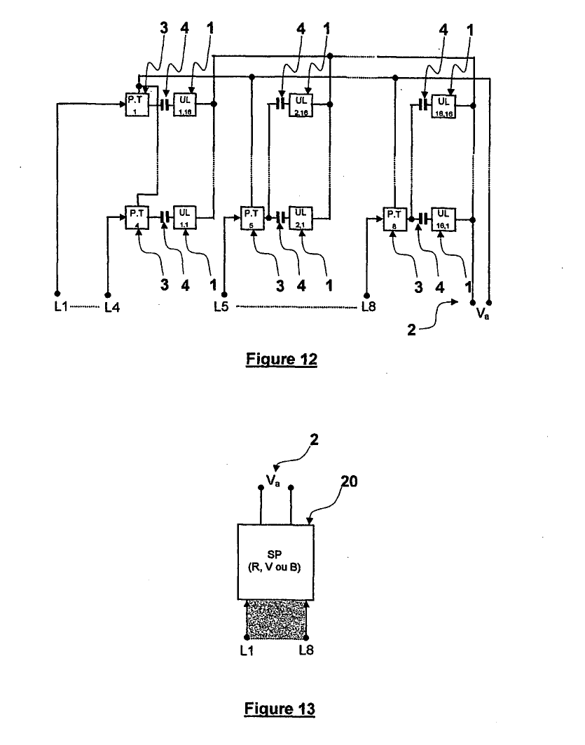

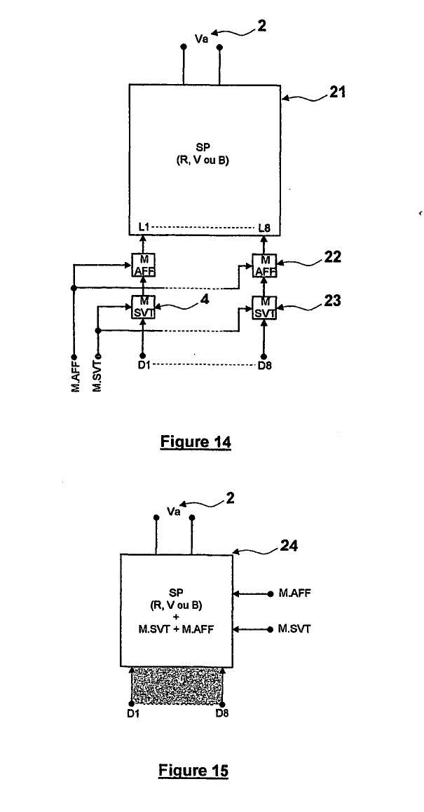

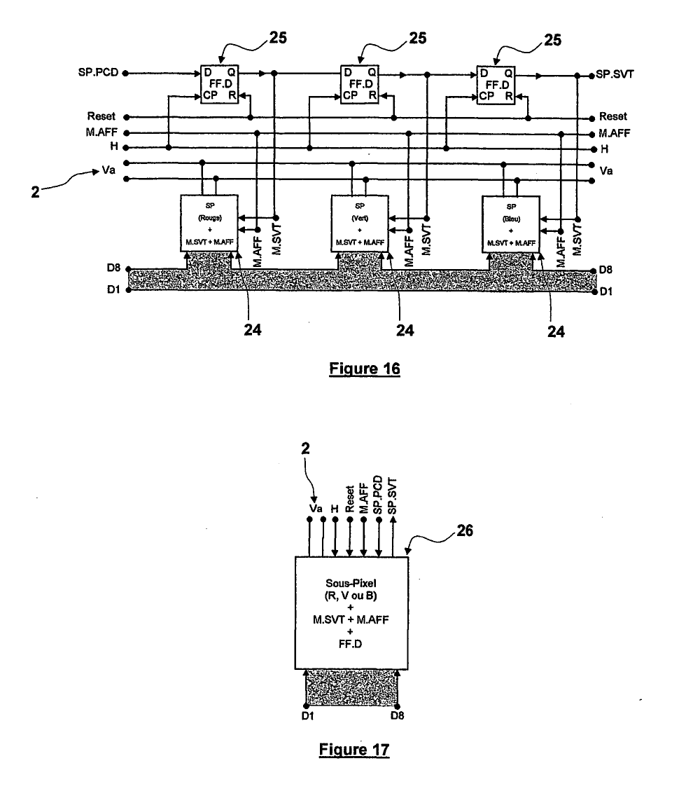

FIG. 14 is a connection diagram of the subpixel, shown in FIG. 13, associated with a double memory device in accordance with a preferred embodiment of the invention. A circuit 21 symbolizes all elements described by FIG. 12 with connections to input source 2 Va and to digital control inputs L1-L8. Each input L1-L8 is connected to the outputs of single bit memory flip-flops such that the set constitutes an 8-bit display memory 22 having a common digital control M.DIS. The inputs of the display memory 22 are connected to the outputs of the single bit memory flip-flops where the set constitutes an 8-bit next display memory 23 having a digital control loading signal M.NXT. The 8-bit word sent to the subpixel is sent to inputs D1-D8 of the next display memory 23. The function of this arrangement allows storing two different 8-bit words depending on the application of the loading control on M.DIS or M.NXT. The 8-bit word stored in the next display memory 23 by the loading control M.NXT corresponds to a binary impulse value of the next total flux φsp of the subpixel. The 8-bit word stored in the display memory 22 corresponds to the binary impulse value of the total flux φsp that is actually emitted or displayed by the subpixel. When the loading control is applied on M.DIS, the 8-bit word stored in the next display memory 23 is transferred to the display memory 22. While the subpixel emits impulses of total flux φsp determined by the value of the 8-bit word stored in the display memory 22, it is possible to load another 8-bit word in the next display memory 23 corresponding to the values of impulses of the total flux φsp that will be emitted by the following subpixel. Thus, the refresh rate of the value displayed by the subpixel is separated from the loading rate, or rate of change of the displayed value. For an 8-bit binary word stored in the display memory 22 and corresponding to the value of total flux φsp emitted by the impulses of the subpixel, the impulse rate corresponds to refresh rate of the subpixel, which depends only on the characteristic voltage applied by the input source 2 Va, and can be several kHz or MHz depending on what was explained for FIGS. 5 and 6. The rate of change of an 8-bit word stored in the display memory 22 and which hence corresponds to the value of total flux φsp emitted by impulses of the subpixel, uniquely depends on the rate at which the 8-bit binary word stored in the next display memory 23 is changed or is loaded into the display memory 22, and is thus completely independent of the refresh rate of the subpixel.

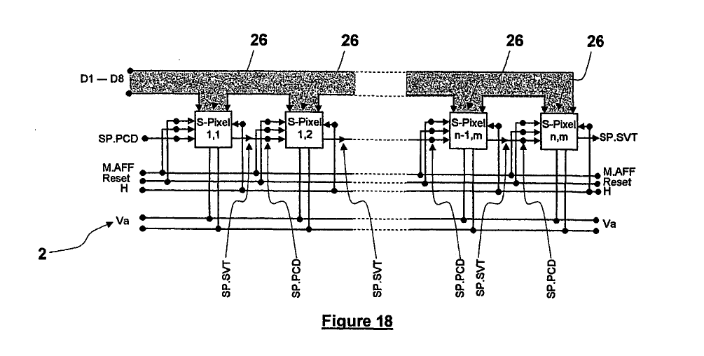

FIG. 15 is an equivalent diagram of the electronic circuit described in FIG. 14. A circuit 24 corresponds to a set of means, described by FIG. 14, with inputs allowing connection to an input source 2 Va, digital input controls D1-D8 for receiving words of n=8 bits corresponding to values of total flux φsp emitted by impulses of the subpixels, as well as a loading input M.NXT for storage in the next display memory and a loading input M.DIS for storage in display memory 22.

From the basic electronic circuits of FIG. 13 or 15, a video screen with a matrix of subpixels can be implemented where the matrix of subpixels are loaded subpixel by subpixel by a classic X,Y matrix addressing device, such as those used for diode matrices, LCD or plasma cells. However, this addressing method is less interesting because it requires decoding integrated circuits external to the display screen device, whereas none is needed with the preferred methods of addressing that will now be described, implemented in a manner internal to the device using integrated circuits and which is the object of the present invention.

FIG. 16 is an electronic connection diagram of a set of three subpixels, as in FIG. 15, associated with a loading device in accordance with a first preferred embodiment. The equivalent circuit described in FIG. 15 is found in the three circuits 24 with inputs connected to the input source 2 Va and inputs D1-D8 connected to a common data bus. The loading input of the display memories 22 for the three circuits 24 are connected together such that a loading signal M.DIS can be sent at the same time. To identify the subpixel concerned by the data on the bus D1-D8, three means 25 are used. The three means 25 are D flip-flops (DFF) connected in series like in a shift register. The inputs CP of the DFF are connected to a common clock source C whereas the inputs R are connected to a common Reset.

Input D of the first DFF (from the left) is connected to an input SP.PCD, where input D originates from a preceding subpixel, if one exists, otherwise input D will originate from an electronic control circuit. An output Q of the first DFF is connected to both an input M.NXT of a first circuit 24 for input loading of a next display memory 23 and to an input D of a second DFF. The second DFF and the third DFF are connected according to the same principles for loading each input to the next display memory 23 of the next two corresponding circuits 24 using the output Q. The output Q of the third DFF is also connected to an output SP.NXT and allows for a connection to the input SP.PCD, hence to the input D of the loading DFF of the next subpixel, if it exists. An example will better illustrate the operation of the set for loading data corresponding to each red, green and blue subpixel forming a RGB pixel. Suppose FIG. 16 is a first group of three subpixels forming a RGB pixel. At initialization, a Reset signal is applied. For example, a zero (0) resets all the DFF 25 to zero. The input M.DIS of the three circuits 24 is also zero, clearing the display memories 22 and preventing any modification of their contents. All the outputs Q of the DFF 25 are zero, and consequently the input M.NXT of all the red, green and blue subpixels do not permit loading of the input into the next display memory 23. At a first clock edge C (applied to all the inputs CP of the DFF 25), a first 8-bit word is sent on the bus to the inputs D1-D8 and a single loading impulse of logical one (1) is sent to the input SP.PCD which is connected to input D of the first DFF. The first 8-bit word corresponds to the value of the next total flux φsp that will be emitted by the red subpixel. The loading impulse applied to D appears at the output Q of the first DFF and affects the input M.NXT of the next display memory 23 of the first circuit 24 corresponding to the red subpixel by permitting the loading of the first 8-bit word destined for the next display memory 23. Since the other outputs Q of the other two DFF are still zero, the other outputs Q do not permit loading the inputs M.NXT of the other two circuits 24 corresponding to the green subpixel and the blue subpixel respectively, and hence prevents storage of data currently on the bus into the next display memory 23. At a second clock edge, the 8-bit word corresponding to the value of the next total flux φsp emitted by the green subpixel is sent on the bus. The loading impulse present at the output Q of the first DFF and which is applied to the input D of the second DFF and which corresponds to the green subpixel, appears at the output Q and permits loading the input M.NXT of the next display memory 23 for the green subpixel. This permits placement of the 8-bit word destined for the next display memory 23. Since the output Q of the first DFF corresponding to the red subpixel has returned to zero and the output Q of the third DFF corresponding to the blue subpixel remains zero, their inputs M.NXT do not permit loading their next display memories. At a third clock edge, the 8-bit word on the bus corresponding to the value of the next total flux φsp emitted by the blue subpixel is stored in the same manner. The loading impulse is present and available at the output Q of the third DFF, and hence at the output SP.NXT for the next subpixels. During the loading of data corresponding to each subpixel into the next display memory 23, the input M.DIS of circuits 24 remains zero, not permitting loading the display memories 22. Whatever the 8-bit word stored in the display memories 22, at initialization this word can be all ones for example, this contents have not been modified by the loading of the next display memories 23 and all the RGB subpixels have emitted values of total luminous flux φsp corresponding to the contents in the display memories 22 at a rate corresponding to their basic impulses.

FIG. 17 is an equivalent diagram of an electronic circuit of a single subpixel with a loading device. A circuit 26 represents a single circuit 24 with a single DFF 25, in accordance with FIG. 16, with inputs connected to the input source 2 Va, inputs D1-D8 connected to the data bus, an output SP.NXT coming from the output Q of the DFF 25 and for transmitting the loading signal for the next display memory 23 to the next subpixel, an input SP.PCD for receiving the loading signal for the next display memory 23 coming from the output Q of DFF 25 of the preceding subpixel, an input M.DIS for receiving the loading signal from the display memory 22, an input for receiving the Reset signal at an input R of the DFF 25, and an input for receiving the clock signal C at the input CP of the DFF 25.

The electronic circuit will therefore be capable of serving as a base for implementing a chain of subpixels in order to form a complete video screen. The digital circuit is simple so an integrated circuit comprising a block of many subpixels can be achieved.

FIG. 18 is an electronic connection diagram of a set of n by m (n,m) subpixels for forming a circuit block of (n,m) subpixels in accordance with a first preferred embodiment. In the circuit block there are the inputs of means 26, as described in FIG. 17, which are connected to the input source 2 Va, the inputs D1-D8 are connected to the data bus, the outputs SP.NXT transmit the loading signal for the next display memories 23 to the next subpixels, the inputs SP.PCD receive the loading signal for the next display memories 23 coming from the preceding subpixel, the input M.DIS simultaneously receives the loading signal for the set of display memories 22 of the set of subpixels, the input Reset permits simultaneous reset of the set of DFF 25 for all the circuits 26 to zero, and the input C simultaneous applies the clock signal C to the set of subpixels (n,m), connected in accordance to the first preferred embodiment. The operation is the same as described in FIG. 16 except there are more subpixels.

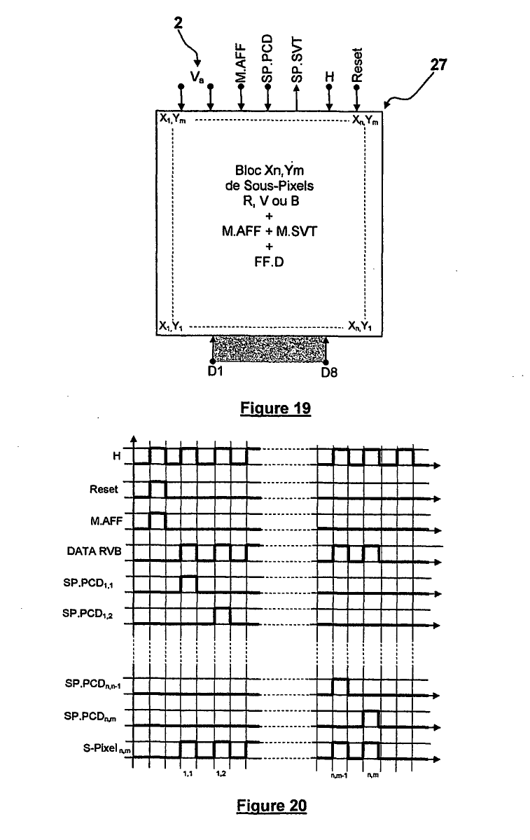

FIG. 19 is an equivalent diagram for the electronic circuit of the block of (n,m) subpixels with a circuit 27 formed from the set of elements shown in FIG. 18. The inputs are connected to the input source 2 Va, the inputs D1-D8 are connected to the data bus, the outputs SP.NXT transmit the loading signal for the next display memory 23 to the subpixels for the next block of (n,m) subpixels, the inputs SP.PCD receive the loading signal for the next display memory 23 which comes from the preceding block of (n,m) subpixels, the input M.DIS simultaneously receives the loading signal for the set of display memories 22 for the set of subpixels of the block, the input Reset simultaneously resets the set of DFF 25 to zero for all the circuits 26 of the block, and the input C simultaneous applies the clock signal C to the set of DFF 25 to the block of (n,m) subpixels connected in accordance to the first preferred embodiment.

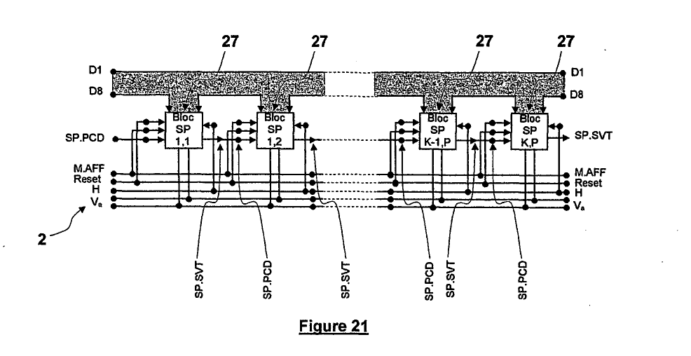

FIG. 20 is a timing diagram of the electronic circuit forming the block of (n,m) subpixels, as in FIG. 19. Shown, are pulse trains for the clock C, Reset, M.DIS, Data RVB, SP.PCD numbered from (1,1) to (n,m), and the graph representing the loading of each subpixel S-Pixel (n,m). From the beginning of Reset, which can correspond to the loading signal M.DIS for the set of display memories 22, the diagram shows that at each clock edge C the data bus has an 8-bit word corresponding to the next value of the R, G or B subpixel, whereas the loading signal at the output of the preceding subpixel SP.PCD (n,m) permits loading of the sub pixel S-Pixel (n,m) having the same indices. The loading rate of the next display memories 23 is thus a function of the clock C rate which synchronizes the stream of data on the DATA RGB bus applied to the inputs D1-D8 of FIG. 19.

FIG. 21 is an electronic wire diagram of the set of (K,P) circuits blocks of (n,m) subpixels composed from the circuits 27 described by FIG. 18 and forming a screen of (K,P) blocks of (n,m) subpixels, in accordance with a first preferred embodiment. The circuits 27 of (n,m) subpixels are connected to the same input source 2 Va and to the inputs D1-D8 connected to a common data bus. The loading inputs M.DIS of the display memories 22 are connected together. Likewise, are the inputs for the clock C and Reset. When the preceding block has filled all its next display memories with the data destined to them, the loading signal M.NXT appears at the output SP.NXT to load the first subpixel at the input SP.PCD of the next circuit block of (n,m) subpixels. When all the circuits 27 have filled their next display memories 23, the set of values for all the subpixels corresponding the next image becomes available in the set of next display memories 23. At this moment, the loading signal for the next image is sent to the input M.DIS that simultaneously permits the transfer of contents of all the next display memories 23 of all circuits 27 into the display memories 22. A new image appears at once in its entirety, like an image from a motion picture film projector. In this manner, the displayed image is refreshed in its entirety at a rate of the luminous impulses 16 determined by the input source Va, at several kilo or mega Hertz, such that the image is loaded or changed at a loading signal rate M.DIS of the display memories 22 of 25-30 images/s or 25-30 Hertz. The objective to separate the image refresh rate from the image loading or change rate has been achieved. The clock C rate of the device that loads the data corresponding to the value of each subpixel is a direct function of the number of subpixels, hence the resolution of the image. For example, for an image resolution of 640×480 pixels, the clock rate would be equal to 640×480×3 subpixels×25 images/s=23.04 MHz in Europe, and 640×480×3 subpixels×30 images/s=27.648 MHz in North America. For high resolution images, for example 1600×1200, the clock rate is 1600×1200×3×25=144 MHz in Europe and 1600×1200×3×30=172.8 MHz in North America, which are not difficult rates to achieve for video circuits that are entirely digital.

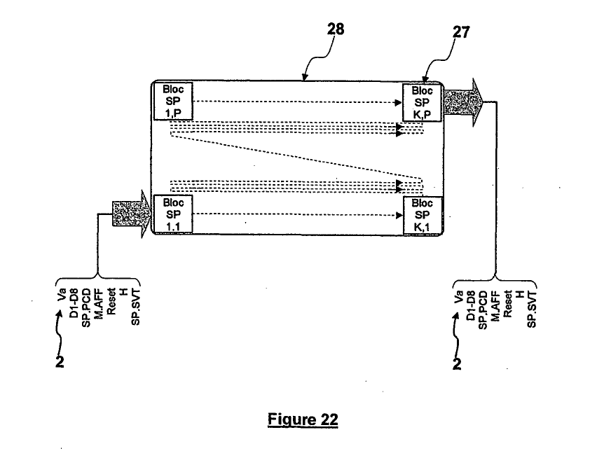

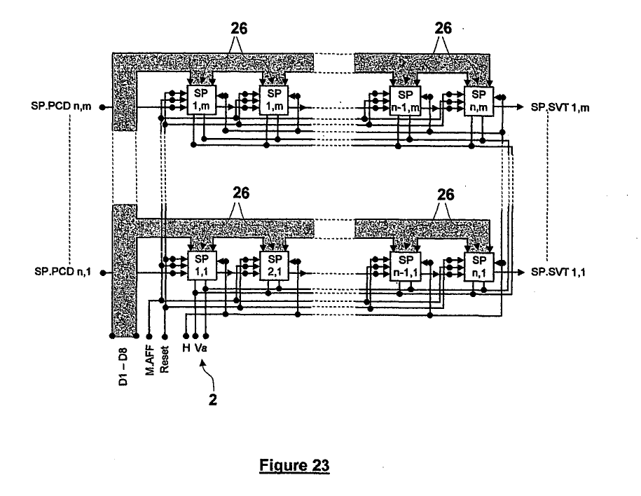

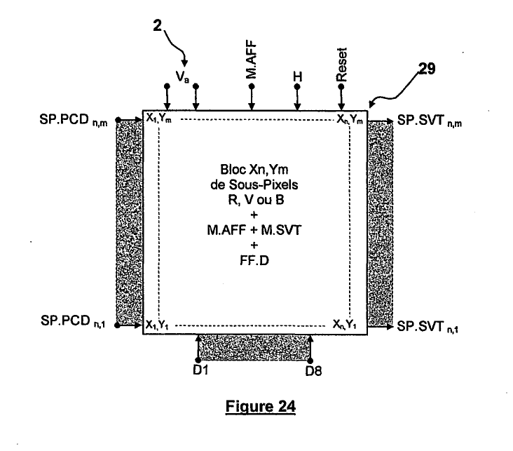

FIG. 22 is an electronic connection diagram of a video screen formed of (K,P) blocks of subpixels, as in FIG. 21, according to the first preferred embodiment. Shown, are blocks of subpixels 27 numbered from (1,1) to (K,P) arranged on a support 28 which is a printed circuit substrate on which there are paths connecting the (K,P) blocks of (n,m) subpixels to the input source 2 Va, the inputs D1-D8 to the data bus, the outputs SP.NXT for loading the next display memories 23 of the next block of subpixels, the inputs SP.PCD for loading the next display memories 23 coming from the preceding block of subpixels, the respective corresponding inputs for the simultaneous loading signal M.DIS of all display memories, the clock signal C and the Reset signal. All the information is available on the printed circuit substrate and allows connection to many like screens for forming a larger screen without it being necessary to use external video circuits. The preferred embodiment of the video screen achieves three of the five characteristics identified as the objective. First, it is an entirely digital display device that has a small thickness since it is formed of an array of (K,P) integrated circuits 27. Second, the refresh rate is very high and independent from the resolution, the rate of change, and the image display dimension since it is uniquely the function of the input voltage Va which causes the luminous impulses of total basic flux φsp. Third, each displayed image appears at once, without any pixel scanning or matrix addressing since all the circuits 27 are connected to a common data bus and it is the simultaneous loading signal M.DIS of the display memories 22 that transfers all at once the contents of the set of next display memories 23 to the set of display memories 22, such that the image appears globally like the image from a motion picture film projector.

Two other preferred embodiments will now be described for a video screen having the same characteristics, but concerned more specifically with the connection of the subpixels to the next display memory 23 and the display memory 22 for forming circuit blocks of subpixels or pixels and finally, a video screen.

FIG. 23 shows an electronic connection diagram of a block of (n,m) subpixels, as in FIG. 17, forming a block of (n,m) subpixels in accordance to a second preferred embodiment. The interconnection of subpixels and their operation are identical to what was described in FIG. 18, except that this wiring achieves a grouping of (m) lines of (n) circuits of subpixels 26. Thus, there are (m) inputs SP.PCD with index (n, l to m) for loading a line (m) of circuits 26 for a current block, and (m) outputs SP.NXT with index (l, 1 to m) for loading a first pixel for each of the lines (m) for a next block.

FIG. 24 is an equivalent diagram of an electronic circuit of a block of (n,m) subpixels in accordance with the second preferred embodiment. A circuit 29 made from the circuits described in FIG. 23 has inputs connected to the input source 2 Va, inputs D1-D8 connected to the data bus, outputs SP.NXT indexed (n, 1 to m) for transmitting a loading signal of the last subpixels (n) of (m) lines for the current block to the next block of pixels, inputs SP.PCD indexed from (n, 1 to m) for receiving loading signals coming from the last subpixels (n, l to m) from the preceding block of subpixels, input for receiving the simultaneous loading signal M.DIS for the set of display memories 22 of circuit 29, input for receiving the simultaneous Reset signal for the set of DFF 25 for circuit 29., and input for receiving the clock signal C simultaneously applied to the set of DFF 25 of circuit 29 in accordance with the second preferred embodiment.

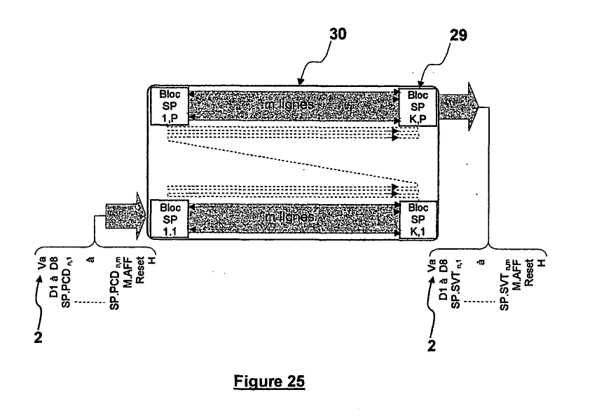

FIG. 25 is an electronic connection diagram of a video screen formed from (K,P) blocks of (n,m) subpixels in accordance with the second preferred embodiment. There are (P) lines of (K) circuits 29 that are arranged on a support 30 which is a printed circuit substrate of interconnections for connecting the blocks of subpixels in the manner described by FIG. 22, except that for each line (m) of each line (P) of circuit 29, loading inputs M.PCD (1) for the first next display memories 23 of each line (m) of each block (K) of subpixels are connected to the last loading outputs M.NXT (n) of the next display memories 23 for the same line (m) of the preceding block (K-1). The last loading output (n) of the next display memory 23 for the line (m) of block (K) is connected to the loading input (2) of the first next display memory 23 for the line (1) of block (1, P+1). In this manner, the data is loaded line by line for the set of circuits 29 situated on the same line (P) and propagates line by line (m) for blocks (P). The second embodiment for assembly allows for a data stream on the bus arriving at inputs D1-D8 corresponding to each subpixel and which is directly compatible with the data stream issued from a line scanning and frame digital video source, since all the same lines (m) for the lines for the (K) blocks are filled one after another, to fill the screen line by line. In the wire assembly described in the first embodiment of FIGS. 21 and 22, the data stream is modified since each block of subpixels must be filled before filling the next one. In this case also, many similar screens can be connected to form an array without using external video circuits also, because all the signals are available on the printed circuit substrate 30.

FIG. 26 is an electronic connection diagram of a set of three subpixels, as in FIG. 5, with a loading device for forming a triplet, referred to as pixel, in accordance with a third preferred embodiment. The same assembly as for FIG. 16 is present, with the same inputs and outputs except that there is only one means 25 for simultaneously loading the three circuits 24 forming a red, green and blue triplet, or RGB pixel, that the data bus sends 24-bit words to the inputs D1-D8 (in a non-limiting example, the 24-bit words are distributed to each subpixel as 1-8 for blue, 9-16 for green, and 17-24 for red), that the loading input M.NXT of the next display memories 23 for the three circuits 24 are connected to the output Q of DFF 25 and the output Q permits loading the next display memories 23 for the next pixel using output P.NXT, and that the input D of DFF 25 is connected to the input P.PCD which receives the loading signal coming from the output Q of DFF 25 of the preceding pixel.

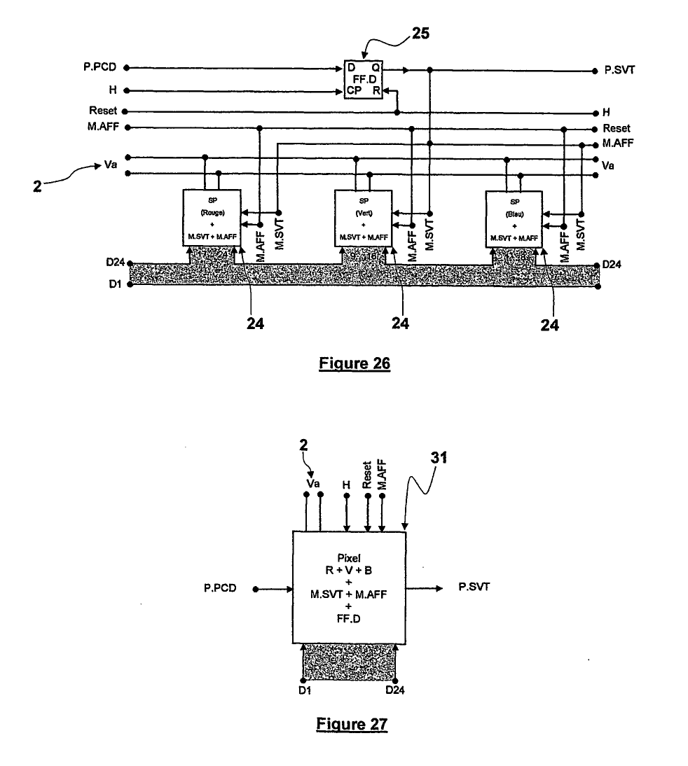

FIG. 27 is an equivalent diagram of the electronic circuit of a triplet, referred to as RGB pixel, in accordance with the third preferred embodiment. The means 31 is shown in FIG. 26. The connections are the same as in FIG. 17, except there are 24 inputs D1-D24, an input P.PCD (instead of SP.PPDD), and an output .NXT (instead of SP.NNTT)

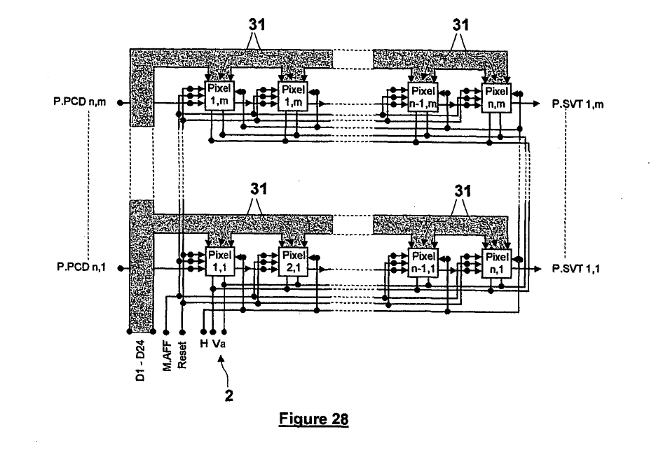

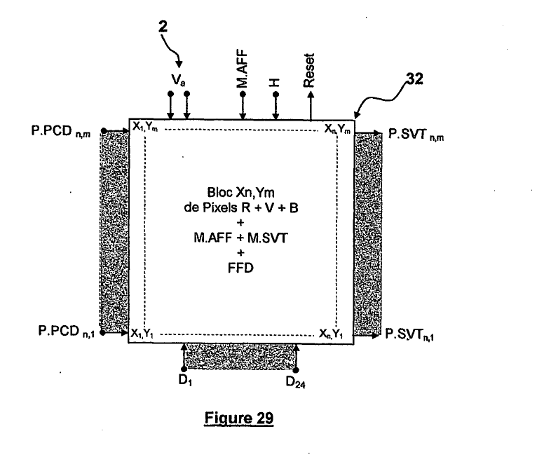

FIG. 28 is an electronic connection diagram of a block of (n,m) pixels 311, as in FIG. 27, in accordance with the third preferred embodiment. The connections and the operation are similar to what is described in connection with FIG. 23. That is, a grouping of (m) lines for (n) circuits 31, except that the data bus is now 24 bits connected to inputs D1-D24, that the loading inputs of the next display memories 23 for the preceding pixels are P.PCD (n, l to m), and that the loading outputs of the pixels for the next blocks are P.NXT (n, 1 to m).

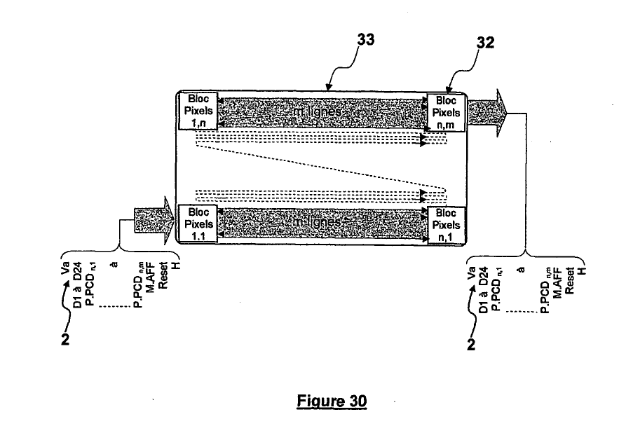

FIG. 29 is an equivalent diagram of the electronic circuit of the block of (n,m) pixels in accordance with a third preferred embodiment. The circuit 32 described by FIG. 28 is connected in a manner identical to FIG. 24, except that the data bus is now 24 bits connected to inputs D1-D24, that the loading inputs of the next display memories 23 for the preceding pixels are P.PCD (n, 1 to m), and that the loading outputs of the pixels for the next blocks are P.NXT (n, 1 to m).

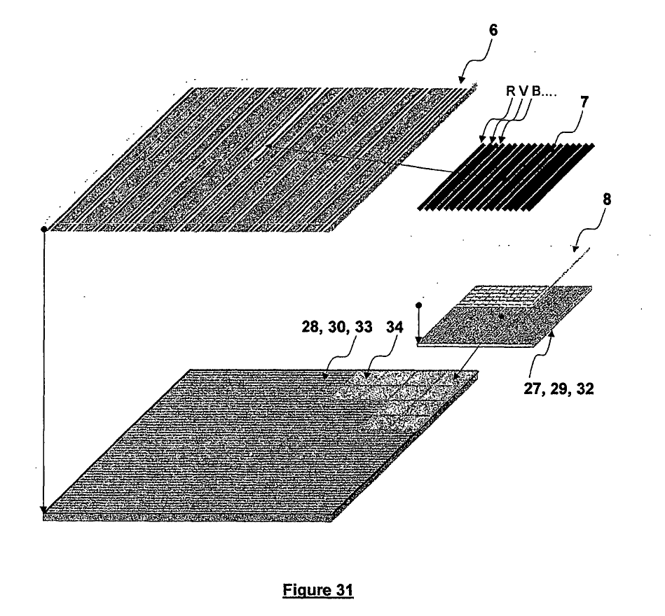

FIG. 30 is a connection diagram of a video screen made up of (n,m) blocks of pixels, as in FIG. 29, in accordance with the third preferred embodiment. The wiring and operation are the same as described by FIG. 25, except that the printed circuit substrate 33 of interconnections on which the (K,P) circuits 32 are connected transport a data bus of 24 bits connected to inputs D1-D24. The advantage of a data bus assembly of 24 bits is to allow a reduction in the loading rate of the data into the next display memories 23 of the subpixels, since the data does not arrive one 8-bit word after another for red, green and blue, but arrives in parallel at the same time on 24 bits. For example, for a resolution of 640×480, the clock rate is equal to 640×40 pixels×25 images/s=7.68 MHz in Europe and 640×480×30 images/s=9.216 MHz in North America. For high resolution images, for example 1600×1200, the clock rate is 1600×1200 pixels×25 images/s=48 MHz in Europe and 1600×1200 pixels×30 images/s 57.6 MHz in North America, which are not difficult frequencies to attain for entirely digital video circuits.

Three out of five characteristics identified as objectives are achieved by the screens. First, the invention provides a display device that is entirely digital having a reduced thickness, similar to an LCD screen. Second, the refresh rate is high and independent of the resolution, the image change rate and the display dimensions of the images. Third, each displayed image appears at once, without pixel scanning or matrix addressing.

FIG. 31 is a video screen showing its principal constituents. Each integrated circuit 27, 28 or 32, in accordance with one of the three non-limiting preferred embodiments, is sealed by the electrode 8 which allows the photon flux 15 emitted by luminescence of the ionized gas 14 found in between, to pass through. The electrode is common to the set of luminous units LU of the integrated circuit since it is directly connected to the input source 2 Va. The set 27, 29 or 32 and 8 each form integrated circuits 34, which are wired to form an array on a printed circuit substrate 28, 30 or 33, implemented according to one of the three preferred embodiments indicated, and have paths for the source Va, for the 8 or 24-bit data bus, for the clock C and for Reset, for loading M.DIS of the display memories 22 and for loading M.NXT of the next display memories 23. To obtain colors, a transparent support 6 is placed on top of the array of integrated circuits 34. A matrix composed of three substances 7 is deposited on the inside face of the transparent support 6. Depending on their composition, the three substances emit by luminescence 16 a red, green or blue color when the substances are excited by the impulses of photon flux 15 emitted by the integrated circuits 34. In a non-limiting example, the support 6 is made by screen printing that is overlaid, subpixel to subpixel, onto the integrated circuits 34, hence forming a one-piece, uniform display surface even if there are many printed circuit substrates 28, 30 or 33 underneath.

In this manner, the fourth objective is achieved, which is to provide a video screen of reduced thickness and a one-piece display surface with dimensions above 42 inches diagonal, referred to as a giant screen.

With this type of integrated circuit, cylindrical screens can be implemented because the integrated circuits 34 can be connected to flexible printed circuit substrates, and the support 6 that goes on top can also be flexible. Since the integrated circuits 34 can have a hexagonal shape, it is possible to connect these to a printed circuit substrate of the same shape and thus obtain spherical screens.

The objectives concerning the five principal characteristics of the digital video screen device implemented in the form of an integrated circuit, being object of the present invention, are thus achieved.

Thus, the digital video screen device comprises one or more printed circuit substrates on which are mounted one or more integrated circuits covered by a one-piece display surface which is covered by one or more luminescent substances that are excited by the integrated circuits placed underneath, such that:

a) for each subpixel 18 belonging to an image point displayed by the video screen, there is a certain number of corresponding basic luminous units 1 which each emit a basic photon flux φe corresponding to an intensity of basic colors, when activated,

b) the basic luminous units 1 forming each subpixel 18 are all connected on the one hand, to a common terminal of a suitable input source 2 Va, on the other hand are activated or deactivated by the intermediary of electronic switches 3 that, respectively connect or disconnect one or more basic luminous units 1 at the same time to another terminal of the input source 2 Va according to binary words that are applied to logic controls, the binary words corresponding to values for desired color intensities for each subpixel,

c) each activated basic luminous unit 1 emits the basic flux of photons φe, in a continuous or pulsed fashion, which combines with other continuous or pulsed basic flux of photons φe emitted at the same time by other basic luminous units 1 of the activated subpixel to which they belong, to form a continuous total continuous or pulsed flux of photons φsp that corresponds to the color intensity of the subpixel,

d) all the activated basic luminous units 1 of all the subpixels of the screen emit basic photon flux φe in a continuous manner or at a given impulse rate, depending only on the input source 2 Va, depending on whether the input source is continuous or alternating in nature,

e) the impulse rate of the set of total flux φsp, corresponding to the color intensity emitted at the same time by all the subpixels for all image points of the screen, corresponds to a refresh rate of an image displayed by the video screen, and is thus uniquely a function of the input source 2 Va that is continuous or at a given frequency suitable to the nature of the basic luminous units 1,

f) for each subpixel, each associated electronic switch 3 has a logic control connected to an output of a flip-flop forming a display memory 22 of the subpixel and uses a loading display input for storing a value of a binary word corresponding to the color intensity displayed by the subpixel,

g) the total continuous flux or pulsed φsp corresponding to the color intensity emitted by a subpixel is combined with the total continuous flux or pulsed φsp corresponding to the color intensity emitted at the same time by the two other subpixels, together forming a RGB triplet for obtaining, by the addition of three colors, the color of the corresponding image point,

h) the combination of three colors for the set of total continuous or pulsed flux φsp corresponding to the intensity of colors emitted at the same time by all subpixels forming the RGB triplets for all image points, therefore corresponds to all the colors of the image displayed by the video screen,

i) all loading inputs to the flip-flops for the display memories 22 for all the subpixels of the screen are connected together allowing simultaneous loading,

j) all the inputs to the flip-flops forming the display memory 22 of each subpixel are connected to outputs of the flip-flops forming the next display memory 23 of each sub pixel, where the loading input permits loading binary words corresponding to the intensities of next colors that will be displayed later by the screen's subpixels,

k) the binary words corresponding to the next color intensities that will be displayed next by the subpixels are put on the inputs of the next display memories 23 by a common data bus which connects all the next display memories 23 of each of the screen's subpixels,

l) a device 25 allows loading the input with a current binary word into the subpixel's next display memory 23 such that when all the next display memories 23 of all the subpixels of the screen have received the binary words destined to them, a signal is applied to a common loading input of the display memories 22 of all the screen's subpixels, allowing simultaneous transfer of the contents of the next display memories 23 to the display memories 22 to display all at once on the screen a next image in its entirety,

m) while the image is displayed in its entirety in a permanent manner or at a given rate, the next display memories 23 can be loaded with a set of binary words corresponding to the colors of the next image at a rate that depends on an image change rate and on an image resolution, hence allowing separation of a loading rate or a change rate of the next image from a refresh rate of the displayed image,

n) each basic luminous unit 1 is a gas cell 14 contained between, on one hand, a transparent support 6 coated by a luminescent substance 7 and by an electrode 8 directly connected to an input source 2 Va, and on the other hand, an insulated support 9 on which is provided a capacitance 4 surrounded by an insulator 13, the capacitance being formed by depositing an electrode 10 onto a dielectric 12, which itself is placed on an electrode 11 that is connected to a transfer gate 3, which is connected to the other terminal of the input source 2 Va such that depending on the state of a logical input control L, the transfer gate 3 either conducts or blocks application of the input source 2 Va,

o) the gas 14 can be similar to those used in plasma screens and possesses an ionization voltage |Vi| that is characteristic of its pressure and composition,

p) the input source 2 Va therefore generates a periodic input voltage with a peak-to-peak value slightly greater than a multiple of an absolute value of the ionization voltage |Vi| of the gas 14,

q) the capacitance 4 can have a value from a few pico to dozens of nano-Farads, depending on the conductivity of gas 14 when ionized and depending on the value of ionization time Ti that is desired as basic time Te for the basic flux φe, and determined to limit a current discharged by the source 2 through the ionized gas 14, and catch-up the input voltage Va to maintain it at this value until a next ionization of the gas 14, which thus always acts as a plasma functioning in a mode of subnormal or normal luminous ionization impulses with an instantaneous current consumption on the order of a few micro or dozens of microamperes,

r) the electrode 8 is a fine conducting grid or is transparent to luminous impulses 15 emitted by the gas 14,

s) the luminescent substance 7 has a composition similar to that used for plasma screens, and its role is to transform the luminous impulses 15 emitted by the gas 14, when ionized, into luminous impulses 16 having a visible wavelength characteristic of its composition,

t) when the transfer gate 3 is blocked by the application of a logic signal corresponding to a logic control L, the gas 14 does not ionize and the basic luminous unit 1 is inactive, whereas when the transfer gate 3 is made to conduct by a logic signal corresponding to a logic control L, the basic luminous unit 1 is activated and the gas 14 ionizes as soon as an absolute value of the input voltage |Va| applied to terminals 8 and 10 is equal to the absolute value of the ionization voltage |Vi|, such that the current that it conducts charges the capacitance 4, which catches up to and then remains at the input voltage Va since the ionization is stopped until the absolute value of the input voltage |Val is once again equal to the absolute value of the ionization voltage |Vi|, and generates another luminous impulse 15 that will be transformed into another basic luminous impulse 16,

u) a rate of luminous ionization impulses 15 transformed into luminous impulses 16 is solely a function of the peak-to-peak value and the frequency of the input voltage Va, of the value of the ionization voltage |Vi| of the gas 14, and the value of the capacitance 4, and is the same for all the activated basic luminous units 1 for all the subpixels forming the screen, and thus corresponds to the refresh rate of the image displayed,

v) for each subpixel forming the video screen, a number 2 to the power n (2ⁿ) basic luminous units 1 are assembled and on one hand, are all connected to a common terminal of a suitable input source 2 Va, and on the other hand, are activated or deactivated by an intermediary of n transfer gates 3 having logic controls L1-Ln that connect or disconnect 2ⁿ⁻¹ basic luminous units forming a subpixel at the same time to another terminal of input source Va, depending on the n-bit binary words that correspond to the value of desired color intensity for the subpixel and that are applied on the logic controls L1-Ln such that 2ⁿ values of color intensities emitted by luminous impulses 16 for each subpixel are emitted,

w) the set of 2ⁿ basic luminous units 1 forming a subpixel has a common electrode 8 which is connected to the input source 2 Va,

x) the luminescent substance 7 corresponding to a given color covers the set of 2ⁿ basic luminous units 1 forming a subpixel which can be sealed by a means 17, the means 17 also able to serve as a conductor between the common electrode 8 and the input source 2 Va if the inside of the means 17 is coated by an insulator 13,

y) the 2′ basic luminous units 1 with n transfer gates 3 whose logic controls L1-Ln are connected to a display memory 22, itself connected to a next display memory 23, form a base circuit 24 having n inputs Dn, an input M.DIS for permitting loading of the display memory 22, an input M.NXT for permitting loading of the next display memory 23, and two terminals for connection to the input source Va.

z) a base circuit 24 forming a subpixel may include one or n=8 inputs D1 or D1-D8 since the subpixel is formed from one or 256 basic luminous units 1 connected to one or 8 transfer gates 3 in such a way to each control one or (2ⁿ⁻¹) basic luminous units 1, and having a one or 8-bit display memory 22 connected to a one or 8-bit next display memory 23 for use in applications requiring monochrome display screens with or without half-tones that are alphanumeric and/or graphic, or requiring polychrome video display screens,

aa) all the subpixels forming the screen and each represented by the base circuit 24 are connected to a common 8-bit bus by the inputs D1-D8, and have a loading input for the display memory 22 connected between them to a single signal source M.DIS,

bb) each subpixel is associated to a device 25 which is a type D flip-flop comprising an input D connected to an output Q of the device 25 of a preceding subpixel, if one exists, or to the device which sends a 8-bit word on the bus connected to the inputs D1-D8 for the base circuit 24, and comprises an input CP for receiving a clock signal C synchronized with each 8-bit word on the bus, an input R for receiving a Reset signal for resetting the D flip-flop to its initial state, an output Q connected to a loading input M.NXT for the next display memory 23 of the subpixel and to the input D of the device 25 of a next subpixel, if one exists, such that each of the screen's subpixels forms a link of a shift register,

cc) at each clock edge C simultaneously presented to the inputs CP of all the devices 25 of all the screen's subpixels, a store signal propagates from D flip-flop to D flip-flop, allowing loading of the subpixel in the next display memory 23 corresponding to the 8-bit word put on the data bus, and corresponding to the next color intensity that will be displayed next by the subpixel,

dd) for each subpixel forming the screen, the base circuit 24 connected to the device 25 forms a circuit 26 whose inputs D1-D8 are connected to a common 8-bit bus and whose input SP.PCD, coming from the preceding subpixel, allows loadings of the next display memory 23, and having an output SP.NXT for transmitting a loading signal of the next display memory 23 to the next subpixel, and having inputs common to all the screen's subpixels for receiving clock C, Reset, and the signal M.DIS for loading of the display memory 22, and terminals for connection to the input source 2 Va,

ee) a block of n lines of m (n,m) subpixels 18 formed as an integrated circuit 27 in accordance with the circuit 26, where the inputs D1-D8 are connected on an 8-bit common bus, where the input SP.PCD, coming from a preceding block of (n,m) subpixels, allows loading of the next display memory 23, and having an output SP.NXT for transmitting the loading signal of the next display memory 23 to a next block of (n,m) subpixels, and having inputs common to all the screen's subpixels for receiving the clock C, the Reset, and the signal M.DIS for loading the display memory 22, and the terminals for connection to the input source 2 Va and to which a common, transparent electrode 8 is added on top for fixing the set by the intermediary of means 17 to form the integrated circuit 34,

ff) a video screen having a one-piece display is formed by arranging, on a printed circuit substrate 28 comprising an 8-bit common bus connecting to inputs D1-D8, an array of circuits 34 and for linking the inputs SP.PCD to the outputs SP.NXT and having inputs common to all the screen's subpixels for receiving the clock C, the Reset, the signal M.DIS and the input source 2 Va,

gg) the array of circuits 34 constitutes an excitation source subpixel by subpixel for the RGB triplets formed with the luminous substances 7 deposited by screen printing onto the one-piece transparent support 6 placed on top of the set of elements forming the screen whose display surface is of one piece,

hh) the subpixels forming the screen and each represented by the base circuit 24, are connected to a device 25 which is a type D flip flop whose output Q is connected to loading inputs M.NXT for the next display memories 23 by groups of three subpixels, thus forming a circuit 31 for each triplet of screen points,

ii) the inputs of the next display memories 23 are all connected to a 24-bit data bus in such a way as to receive three 8-bit words in parallel corresponding to a triplet at the same time once they are given permission to load, thus permitting a clock rate three times slower for loading of data into the next display memories 23,

jj) the integrated circuits 34 can have shape of a square, rectangle or hexagon arranged on printed circuit substrates 28 having a shape allowing implementation of video screens of reduced thickness and whose display surface can be planar, cylindrical and even spherical.

1. A digital video screen device comprising one or more printed circuit substrates on which one or more integrated circuits are connected, the one or more integrated circuits being covered by a one-piece display surface, the display surface covered by one or more luminous substances excited by the integrated circuits placed underneath, the digital video screen device characterized in that:
a) for each subpixel 18 belonging to an image point displayed by the video screen, there is a certain number of corresponding basic luminous units 1 which each emit a basic photon flux φe corresponding to an intensity of basic colors, when activated,
b) the basic luminous units 1 forming each subpixel 18 are all connected on the one hand, to a common terminal of a suitable input source 2 Va, on the other hand are activated or deactivated by the intermediary of electronic switches 3 that, respectively connect or disconnect one or more basic luminous units 1 at the same time to another terminal of the input source 2 Va according to binary words that are applied to logic controls, the binary words corresponding to values for desired color intensities for each subpixel,
c) each activated basic luminous unit 1 emits the basic flux of photons φe, in a continuous or pulsed fashion, which combines with other continuous or pulsed basic flux of photons φe emitted at the same time by other basic luminous units 1 of the activated subpixel to which they belong, to form a continuous total continuous or pulsed flux of photons φsp that corresponds to the color intensity of the subpixel,
d) all the activated basic luminous units 1 of all the subpixels of the screen emit basic photon flux φe in a continuous manner or at a given impulse rate, depending only on the input source 2 Va, depending on whether the input source is continuous or alternating in nature,
e) the impulse rate of the set of total flux φsp, corresponding to the color intensity emitted at the same time by all the subpixels for all image points of the screen, corresponds to a refresh rate of an image displayed by the video screen, and is thus uniquely a function of the input source 2 Va that is continuous or at a given frequency suitable to the nature of the basic luminous units 11
f) for each subpixel, each associated electronic switch 3 has a logic control connected to an output of a flip-flop forming a display memory 22 of the subpixel and uses a loading display input for storing a value of a binary word corresponding to the color intensity displayed by the subpixel.

2. A device as in claim 1, characterized in that:
a) the total continuous flux or pulsed φsp corresponding to the color intensity emitted by a subpixel is combined with the total continuous flux or pulsed φsp corresponding to the color intensity emitted at the same time by the two other subpixels, together forming a RGB triplet for obtaining, by the addition of three colors, the color of the corresponding image point,
b) the combination of three colors for the set of total continuous or pulsed flux φsp corresponding to the intensity of colors emitted at the same time by all subpixels forming the RGB triplets for all image points, therefore corresponds to all the colors of the image displayed by the video screen,

3. A device as in claims 1 and 2, characterized in that:
a) all loading inputs to the flip-flops for the display memories 22 for all the subpixels of the screen are connected together allowing simultaneous loading,
b) the inputs to the flip-flops forming the display memory 22 of each subpixel are connected to outputs of the flip-flops forming the next display memory 23 of each sub pixel, where the loading input permits loading binary words corresponding to the intensities of next colors that will be displayed later by the screen's subpixels,
c) the binary words corresponding to the next color intensities that will be displayed next by the subpixels are put on the inputs of the next display memories 23 by a common data bus which connects all the next display memories 23 of each of the screen's subpixels,
d) a device 25 permits loading the input with a current binary word into the subpixel's next display memory 23 such that when all the next display memories 23 of all the subpixels of the screen have received the binary words destined to them, a signal is applied to a common loading input of the display memories 22 of all the screen's subpixels, allowing simultaneous transfer of the contents of the next display memories 23 to the display memories 22 to display all at once on the screen a next image in its entirety,
e) while the image is displayed in its entirety in a permanent manner or at a given rate, the next display memories 23 can be loaded with a set of binary words corresponding to the colors of the next image at a rate that depends on an image change rate and on an image resolution, hence allowing separation of a loading rate or a change rate of the next image from a refresh rate of the displayed image.

4. A device as in claims 1 to 3, characterized in that each basic luminous unit 1 is a gas cell 14 contained between, on one hand, a transparent support 6 coated by a luminescent substance 7 and by an electrode 8 directly connected to an input source 2 Va, and on the other hand, an insulated support 9 on which is provided a capacitance 4 surrounded by an insulator 13, the capacitance being formed by depositing an electrode 10 onto a dielectric 12, which itself is placed on an electrode 11 that is connected to a transfer gate 3, which is connected to the other terminal of the input source 2 Va such that depending on the state of a logical input control L, the transfer gate 3 either conducts or blocks application of the input source 2 Va.

5. A device as in claims 1 to 4, characterized in that:
a) the gas 14 can be similar to those used in plasma screens and possesses an ionization voltage |Vi| that is characteristic of its pressure and composition,
b) the input source 2 Va therefore generates a periodic input voltage with a peak-to-peak value slightly greater than a multiple of an absolute value of the ionization voltage |Vi| of the gas 14,
c) the capacitance 4 can have a value from a few pico to dozens of nano-Farads, depending on the conductivity of gas 14 when ionized and depending on the value of ionization time Ti that is desired as basic time Te for the basic flux φe, and determined to limit a current discharged by the source 2 through the ionized gas 14, and catch-up the input voltage Va to maintain it at this value until a next ionization of the gas 14, which thus always acts as a plasma functioning in a mode of subnormal or normal luminous ionization impulses with an instantaneous current consumption on the order of a few micro or dozens of microamperes,
d) the electrode 8 is a fine conducting grid or is transparent to luminous impulses 15 emitted by the gas 14,
e) the luminescent substance 7 has a composition similar to that used for plasma screens, and its role is to transform the luminous impulses 15 emitted by the gas 14, when ionized, into luminous impulses 16 having a visible wavelength characteristic of its composition,
f) when the transfer gate 3 is blocked by the application of a logic signal corresponding to a logic control L, the gas 14 does not ionize and the basic luminous unit 1 is inactive, whereas when the transfer gate 3 is made to conduct by a logic signal corresponding to a logic control L, the basic luminous unit 1 is activated and the gas 14 ionizes as soon as an absolute value of the input voltage |Va| applied to terminals 8 and 10 is equal to the absolute value of the ionization voltage |Vi|, such that the current that it conducts charges the capacitance 4, which catches up to and then remains at the input voltage Va since the ionization is stopped until the absolute value of the input voltage |Va| is once again equal to the absolute value of the ionization voltage |Vi|, and generates another luminous impulse 15 that will be transformed into another basic luminous impulse 16,
g) a rate of luminous ionization impulses 15 transformed into luminous impulses 16 is solely a function of the peak-to-peak value and the frequency of the input voltage Va, of the value of the ionization voltage |Vi| of the gas 14, and the value of the capacitance 4, and is the same for all the activated basic luminous units 1 for all the subpixels forming the screen, and thus corresponds to the refresh rate of the image displayed.

6. A device as in claims 1 to 5, characterized in that:
a) for each subpixel forming the video screen, a number 2 to the power n (2ⁿ) basic luminous units 1 are assembled and on one hand, are all connected to a common terminal, of a suitable input source 2 Va, and on the other hand, are activated or deactivated by an intermediary of n transfer gates 3 having logic controls L1-Ln that connect or disconnect 2ⁿ⁻¹ basic luminous units forming a subpixel at the same time to another terminal of input source Va, depending on the n-bit binary words that correspond to the value of desired color intensity for the subpixel and that are applied on the logic controls L1-Ln such that 2ⁿ values of color intensities emitted by luminous impulses 16 for each subpixel are emitted,
b) the set of 2′ basic luminous units 1 forming a subpixel has a common electrode 8 which is connected to the input source 2 Va,
c) the luminescent substance 7 corresponding to a given color covers the set of 2ⁿ basic luminous units 1 forming a subpixel which can be sealed by a means 17, the means 17 also able to serve as a conductor between the common electrode 8 and the input source 2 Va if the inside of the means 17 is coated by an insulator 13,
d) the 2ⁿ basic luminous units 1 with n transfer gates 3 whose logic controls L1-Ln are connected to a display memory 22, itself connected to a next display memory 23, form a base circuit 24 having n inputs Dn, an input. M.DIS for permitting loading of the display memory 22, an input M.NXT for permitting loading of the next display memory 23, and two terminals for connection to the input source Va.

7. A device as in claim 6, characterized in that a base circuit 24 forming a subpixel may include one or n=8 inputs D1 or D1-D8 since the subpixel is formed from one or 256 basic luminous units 1 connected to one or 8 transfer gates 3 in such a way to each control one or (2ⁿ⁻¹) basic luminous units 1, and having a one or 8-bit display memory 22 connected to a one or 8-bit next display memory 23 for use in applications requiring monochrome display screens with or without half-tones that are alphanumeric and/or graphic, or requiring polychrome video display screens.

8. A device as in claims 1 to 7, characterized in that:
a) all the subpixels forming the screen and each represented by the base circuit 24 are connected to a common 8-bit bus by the inputs D1-D8, and have a loading input for the display memory 22 connected between them to a single signal source M.DIS,
b) each subpixel is associated to a device 25 which is a type D flip-flop comprising an input D connected to an output Q of the device 25 of a preceding subpixel, if one exists, or to the device which sends a 8-bit word on the bus connected to the inputs D1-D8 for the base circuit 24, and comprises an input CP for receiving a clock signal C synchronized with each-8-bit word on the bus, an input R for receiving a Reset signal for resetting the D flip-flop to its initial state, an output Q connected to a loading input M.NXT for the next display memory 23 of the subpixel and to the input D of the device 25 of a next subpixel, if one exists, such that each of the screen's subpixels forms a link of a shift register,
c) at each clock edge C simultaneously presented to the inputs CP of all the devices 25 of all the screen's subpixels, a store signal propagates from D flip-flop to D flip-flop, allowing loading of the subpixel in the next display memory 23 corresponding to the 8-bit word put on the data bus, and corresponding to the next color intensity that will be displayed next by the subpixel,
d) for each subpixel forming the screen, the base circuit 24 connected to the device 25 forms a circuit 26 whose inputs D1-D8 are connected to a common 8-bit bus and whose input SP.PCD, coming from the preceding subpixel, allows loadings of the next display memory 23, and having an output SP.NXT for transmitting a loading signal of the next display memory 23 to the next subpixel, and having inputs common to all the screen's subpixels for receiving clock C, Reset, and the signal M.DIS for loading of the display memory 22, and terminals for connection to the input source 2 Va.

9. A device as in claims 1 to 8, characterized in that a block of n lines of m (n,m) subpixels 18 formed as an integrated circuit 27 in accordance with the circuit 26, where the inputs D1-D8 are connected on an 8-bit common bus, where the input SP.PCD, coming from a preceding block of (n,m) subpixels, allows loading of the next display memory 23, and having an output SP.NXT for transmitting the loading signal of the next display memory 23 to a next block of (n,m) subpixels, and having inputs common to all the screen's subpixels for receiving the clock C, the Reset, and the signal M.DIS for loading the display memory 22, and the terminals for connection to the input source 2 Va and to which a common, transparent electrode 8 is added on top for fixing the set by the intermediary of means 17 to form the integrated circuit 34.

10. A device as in claims 1 to 9, characterized in that:
a) a video screen having a one-piece display is formed by arranging, on a printed circuit substrate 28 comprising an 8-bit common bus connecting to inputs D1-D8, an array of circuits 34 and for linking the inputs SP.PCD to the outputs SP.NXT and having inputs common to all the screen's subpixels for receiving the clock C, the Reset, the signal M.DIS and the input source 2 Va,
b) the array of circuits 34 constitutes an excitation source subpixel by subpixel for the RGB triplets formed with the luminous substances 7 deposited by screen printing onto the one-piece transparent support 6 placed on top of the set of elements forming the screen whose display surface is of one piece.

11. A device as in claims 1 to 10, characterized in that:
a) the subpixels forming the screen and each represented by the base circuit 24, are connected to a device 25 which is a type D flip flop whose output Q is connected to loading inputs M.NXT for the next display memories 23 by groups of three subpixels, thus forming a circuit 31 for each triplet of screen points,
b) the inputs of the next display memories 23 are all connected to a 24-bit data bus in such a way as to receive three 8-bit words in parallel corresponding to a triplet at the same time once they are given permission to load, thus permitting a clock rate three times slower for loading of data into the next display memories 23.

12. A device as in claims 1 to 11, characterized in that the integrated circuits 34 can have shape of a square, rectangle or hexagon arranged on printed circuit substrates 28 having a shape allowing implementation of video screens of reduced thickness and whose display surface can be planar, cylindrical and even spherical.

13. A device as in claims 1 to 12, characterized in that the LU can be simple filament or flash lamps, electroluminescent diodes, thin film electroluminescent, plasma cells, liquid crystal cells, light emitting polymer or micro mirrors.

14. A device as in claims 1 to 13, characterized in that from the base circuit of FIG. 15, a video screen is implemented with a matrix of subpixels loaded subpixel by subpixel by a classic X,Y matrix addressing device such as those used for diode matrices, LCD or plasma cells.
